(19) United States
(12) Patent Application Publication
(10) Pub. No.: US 2024/0006628 A1
(43) Pub. Date: Jan. 4, 2024

(54) UNIT CELL ARCHITECTURE FOR WATER MANAGEMENT IN A FUEL CELL

(71) Applicants: CUMMINS INC., Columbus, IN (US); HYDROGENICS CORPORATION, Mississauga (CA)

(72) Inventors: Udit SHRIVASTAVA, East York (CA); Salvatore RANIERI, Etobicoke (CA); Barathram JAYASANKAR, Mississauga (CA); Ellsworth William BELL, Etobioke (CA); Nathaniel Ian JOOS, Toronto (CA); Ashok KUMAR, Columbus, IN (US)

(21) Appl. No.: 18/342,128

(22) Filed: Jun. 27, 2023

Related U.S. Application Data
(60) Provisional application No. 63/357,972, filed on Jul. 1, 2022.

(51) Int. Cl. H01M 8/026; H01M 8/04119

(52) U.S. Cl. CPC H01M 8/026; H01M 8/04156

(57) ABSTRACT

A fuel cell system having a fuel cell includes an anode, a cathode, a membrane electrode assembly, a bipolar plate, and a microporous layer. The bipolar plate comprises an anode flow field.

### CROSS-REFERENCE TO RELATED APPLICATIONS

This nonprovisional application claims the benefit and priority, under 35 U.S.C. § 119(e) and any other applicable laws or statues, to U.S. Provisional Patent Application Ser. No. 63/357,972 filed on Jul. 1, 2022, the entire disclosure of which is hereby expressly incorporated herein by reference.

### TECHNICAL FIELD

The present disclosure generally relates to systems and methods for increasing the efficiency of a fuel cell by modifying an anode flow field.

### BACKGROUND

Vehicles and/or powertrains use fuel cells, fuel cell stacks, and/or fuel cell systems for their power needs. A fuel cell stack may include a plurality of fuel cells and common aligned features that allow for a single supply cavity or manifold and/or a single return cavity or manifold for each of an anode fluid (e.g., fuel), a cathode fluid (e.g., air or oxygen), and/or a coolant fluid. The aligned features create a stack-long cavity for the flow of anode fluids, cathode fluids, and coolant fluids.

The stack-long cavity facilitates the supply and return of the anode fluid, cathode fluid, and/or coolant fluid to and from all the fuel cells positioned in a parallel flow configuration. Since the fuel cells in the fuel cell stack share a common fuel and oxygen supply source, and are connected to the return cavity or manifold, approximately equal amounts of reactant (e.g., anode fluid and/or cathode fluid) and coolant fluid is diverted to each individual fuel cell through an isolated pathway(s). Such a pathway or channel designed to allow fuel or oxygen to travel over the length of bipolar plates (BPP) in the fuel cell stack is referred to as a flow field.

The efficiency of the fuel cell system can be increased by increasing the efficiency of fuel cell water management. Water management in a fuel cell system can be improved by changing the flow fields at the anode side. Though a typical flow field includes a parallel configuration, flow fields in the fuel cells may exist in a parallel flow configuration, an interdigitated flow configuration, or a mixed flow configuration. Described herein are systems and methods to modify the anode flow field to include more than one type of flow field at the anode side (e.g., a composite flow field). A composite flow field can efficiently remove excess water from both the cathode and the anode sides.

### SUMMARY

Embodiments of the present invention are included to meet these and other needs.

In one aspect, described herein, a fuel cell system comprising a fuel cell includes an anode, a cathode, a membrane electrode assembly, a bipolar plate, and a microporous layer. The membrane electrode assembly is on a first side of an anode gas diffusion layer. The bipolar plate is on a second side of the anode gas diffusion layer. The anode gas diffusion layer comprises an anode flow field. The microporous layer is in between the membrane electrode assembly and the anode gas diffusion layer. The anode flow field comprises at least a first anode flow field configuration and a second anode flow field configuration. Hydrogen flows through the first anode flow field configuration and the second anode flow field configuration of the anode flow fields.

In some embodiments, the first anode flow field configuration may be an interdigitated flow configuration and the second anode flow field configuration may be a parallel flow configuration. In some embodiments, the first anode flow field configuration may be a mixed flow configuration and the second anode flow field configuration may be a parallel flow configuration. In some embodiments, a ratio of a length of the first anode flow field configuration to a length of the second anode flow field configuration may be about 1:1.

In some embodiments, the anode gas diffusion layer may comprise a first anode gas diffusion layer corresponding to the first anode flow field configuration and a second anode gas diffusion layer corresponding to the second anode flow field configuration, and wherein the first anode gas diffusion layer may be hydrophilic and the second anode gas diffusion layer may be hydrophobic. In some embodiments, the hydrophilic first anode gas diffusion layer may cause an anode side hydraulic resistance to be lower than a cathode side hydraulic resistance.

In some embodiments, a pressure drop in the first anode flow field configuration may be about the same as a pressure drop in the second anode flow field configuration. In some embodiments, a velocity of hydrogen flowing through the first anode flow field configuration may be about the same as a velocity of hydrogen flowing through the second anode flow field configuration.

In some embodiments, the first anode flow field configuration may include a first grove of a width about 0.2 mm to 1 mm and the second anode flow field configuration may include a second grove of a width about 0.2 mm to 1 mm. In some embodiments, a first local water saturation at the anode may be lower than a second local water saturation at the cathode.

According to a second aspect, described herein, a method of operating a fuel cell system including a fuel cell stack comprises operating a plurality of fuel cells comprising a membrane electrode assembly on a first side of an anode gas diffusion layer and a bipolar plate on a second side of the anode gas diffusion layer, wherein the anode gas diffusion layer comprises a first anode flow field configuration and a second anode flow field configuration. The method further comprises flowing hydrogen through the first anode flow field configuration and the second anode flow field configuration. The method further comprises increasing efficiency of the fuel cell system by decreasing water accumulation in the fuel cell stack.

In some embodiments, the first anode flow field configuration may be an interdigitated flow configuration and the second anode flow field configuration may be a parallel flow configuration. In some embodiments, the first anode flow field configuration may be a mixed flow configuration and the second anode flow field configuration may be a parallel flow configuration.

In some embodiments, the anode gas diffusion layer may comprise a first anode gas diffusion layer corresponding to the first anode flow field configuration and a second anode gas diffusion layer corresponding to the second anode flow field configuration, and wherein the first anode gas diffusion layer may be hydrophilic and the second anode gas diffusion layer may be hydrophobic. In some embodiments, the method may further comprise recycling water produced in the fuel cell stack by allowing the water to flow through the hydrophilic first anode gas diffusion layer.

In some embodiments, the method may further comprise decreasing a parasitic load on the fuel cell system. In some embodiments, the method may further comprise humidifying air at a cathode inlet of each of the plurality of fuel cells by recycling water produced in the fuel cell stack.

In some embodiments, the method may further comprise humidifying hydrogen at an anode outlet of each of the plurality of fuel cells by recycling water produced in the fuel cell stack. In some embodiments, a pressure drop in the first anode flow field configuration may be about the same as a pressure drop in the second anode flow field configuration. In some embodiments, a fluid velocity in the first anode flow field configuration may be about the same as a fluid velocity in the second anode flow field configuration.

### BRIEF DESCRIPTION OF THE DRAWINGS

FIG. 1A is a schematic view of an exemplary fuel cell system including an air delivery system, a hydrogen delivery system, and a fuel cell module including a stack of multiple fuel cells;

FIG. 1B is a cutaway view of an exemplary fuel cell system including an air delivery system, hydrogen delivery systems, and a plurality of fuel cell modules each including multiple fuel cell stacks;

FIG. 1C is a perspective view of an exemplary repeating unit of a fuel cell stack of the fuel cell system of FIG. 1A;

FIG. 1D is a cross-sectional view of an exemplary repeating unit of the fuel cell stack of FIG. 1C;

FIG. 2 illustrates a fuel cell including a counter flow field design at an anode side and a cathode side;

FIG. 3 illustrates an embodiment of a fuel cell including a single parallel anode flow field;

FIG. 4 illustrates a cross section of a conventional fuel cell architecture including a single parallel anode flow field and a hydrophobic gas diffusion layer (GDL);

FIG. 5A illustrates a top view of a fuel cell including a composite anode flow field, the composite anode flow field may include an interdigitated flow field and/or a mixed flow field and parallel flow field;

FIG. 5B illustrates a fuel cell including a composite anode flow field, the composite anode flow field may include an interdigitated flow field and a parallel flow field;

FIG. 5C illustrates a fuel cell including a composite anode flow field, the composite anode flow field may include a mixed flow field and a parallel flow field;

FIG. 6 illustrates an embodiment of a fuel cell including a composite anode flow field;

FIG. 7 illustrates a cross section of a fuel cell architecture including a composite parallel anode flow field and a hydrophilic gas diffusion layer (GDL);

FIG. 8A illustrates a hydraulic resistance of the different components in the fuel cell illustrated in FIGS. 3 and 4, including a single parallel anode flow field and a hydrophobic gas diffusion layer (GDL);

FIG. 8B illustrates a water saturation profile in the fuel cell illustrated in FIGS. 3 and 4;

FIG. 9A illustrates a hydraulic resistance of the different components in the fuel cell illustrated in FIGS. 5-7, including a composite anode flow field and a hydrophilic gas diffusion layer (GDL);

FIG. 9B illustrates a water saturation profile in the fuel cell illustrated in FIGS. 5-7;

FIG. 10A is a simulation of pressure across an interdigitated anode flow field during hydrogen flow; and

FIG. 10B is a simulation of velocity across an interdigitated anode flow field during hydrogen flow.

These and other features, aspects, and advantages of the present invention will become better understood when the following detailed description is read with reference to the accompanying drawings described herein. Reference is also made to the accompanying drawings that form a part hereof and in which is shown by way of illustration specific embodiments in which the invention may be practiced. These embodiments are described in sufficient detail to enable those skilled in the art to practice what is claimed and it is to be understood that other embodiments may be utilized and that logical, mechanical, and electrical changes may be made without departing from the spirit and scope of the claims. The following detailed description is, therefore, not to be taken in a limiting sense.

### DETAILED DESCRIPTION

The present disclosure is directed to systems and methods used to increase the efficiency of a fuel cell by increasing the efficiency of water management in the fuel cell. The present systems and methods enhance the efficiency of water management in the fuel cell by modifying the anode flow field. Furthermore, the present systems and methods enhance the efficiency of water management in the fuel cell by changing the composition of the gas diffusion layer (GDL) to include a hydrophilic material.

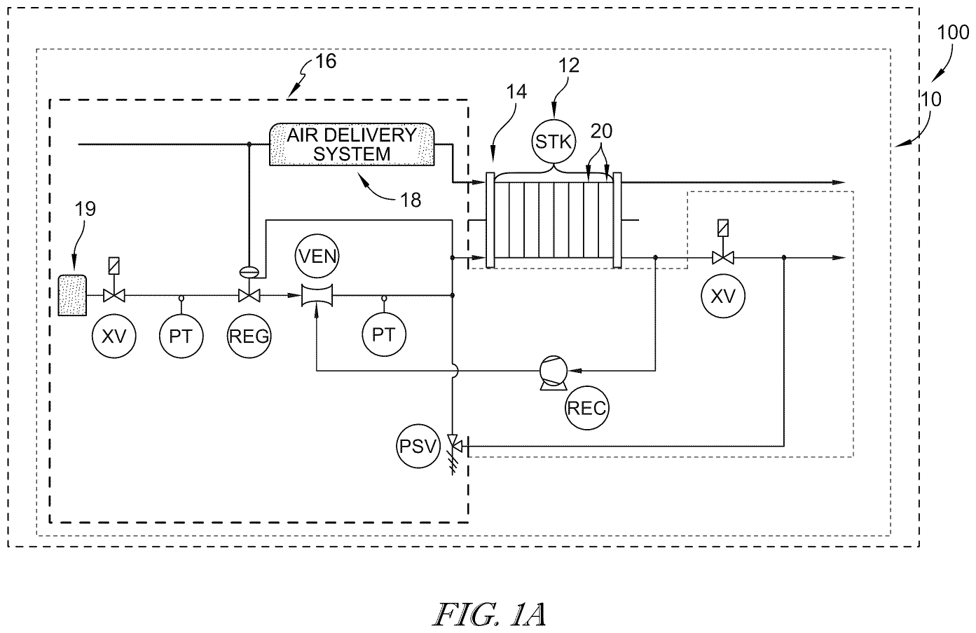

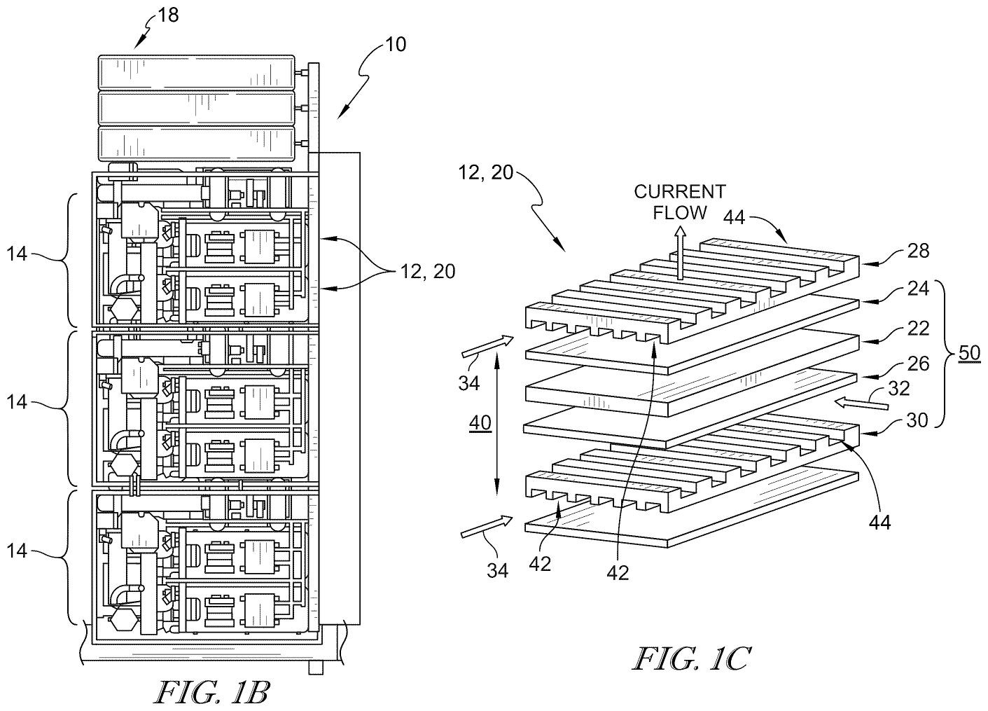

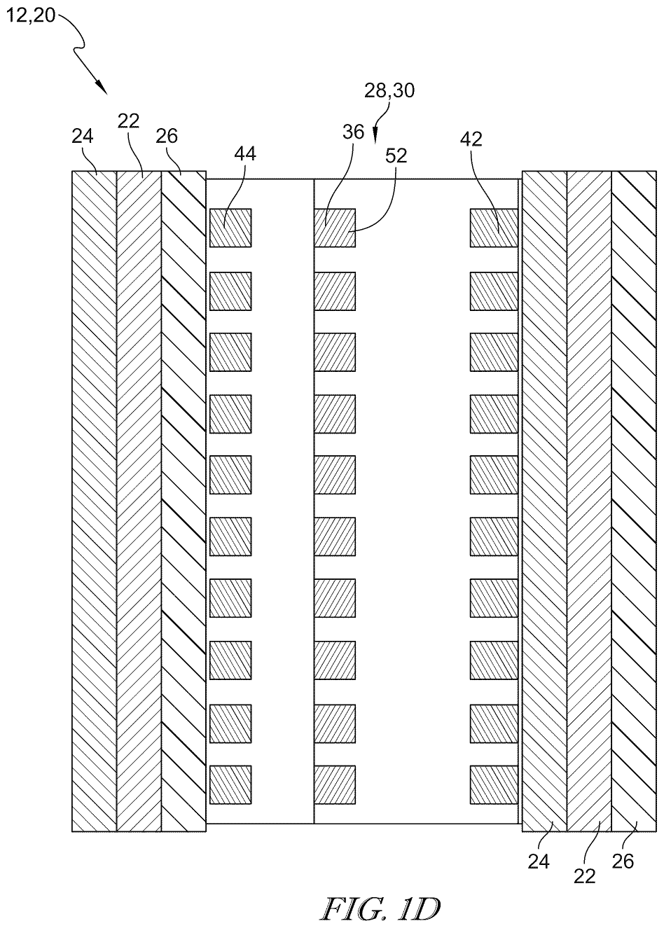

As shown in FIG. 1A, fuel cell systems 10 often include one or more fuel cell stacks 12 (“STK”) or fuel cell modules 14 connected to a balance of plant (BOP) 16, including various components, to support the electrochemical conversion, generation, and/or distribution of electrical power to help meet modern day industrial and commercial needs in an environmentally friendly way. As shown in FIGS. 1B and 1C, fuel cell systems 10 may include fuel cell stacks 12 comprising a plurality of individual fuel cells 20. Each fuel cell stack 12 may house a plurality of fuel cells 20 assembled together in series and/or in parallel. The fuel cell system 10 may include one or more fuel cell modules 14 as shown in FIGS. 1A and 1B.

Each fuel cell module 14 may include a plurality of fuel cell stacks 12 and/or a plurality of fuel cells 20. The fuel cell module 14 may also include a suitable combination of associated structural elements, mechanical systems, hardware, firmware, and/or software that is employed to support the function and operation of the fuel cell module 14. Such items include, without limitation, piping, sensors, regulators, current collectors, seals, and insulators.

The fuel cells 20 in the fuel cell stacks 12 may be stacked together to multiply and increase the voltage output of a single fuel cell stack 12. The number of fuel cell stacks 12 in a fuel cell system 10 can vary depending on the amount of power required to operate the fuel cell system 10 and meet the power need of any load. The number of fuel cells 20 in a fuel cell stack 12 can vary depending on the amount of power required to operate the fuel cell system 10 including the fuel cell stacks 12.

The number of fuel cells 20 in each fuel cell stack 12 or fuel cell system 10 can be any number. For example, the number of fuel cells 20 in each fuel cell stack 12 may range from about 100 fuel cells to about 1000 fuel cells, including any specific number or range of number of fuel cells 20 comprised therein (e.g., about 200 to about 800). In an embodiment, the fuel cell system 10 may include about 20 to about 1000 fuel cells stacks 12, including any specific number or range of number of fuel cell stacks 12 comprised therein (e.g., about 200 to about 800). The fuel cells 20 in the fuel cell stacks 12 within the fuel cell module 14 may be oriented in any direction to optimize the operational efficiency and functionality of the fuel cell system 10.

The fuel cells 20 in the fuel cell stacks 12 may be any type of fuel cell 20. The fuel cell 20 may be a polymer electrolyte membrane or proton exchange membrane (PEM) fuel cell, an anion exchange membrane fuel cell (AEMFC), an alkaline fuel cell (AFC), a molten carbonate fuel cell (MCFC), a direct methanol fuel cell (DMFC), a regenerative fuel cell (RFC), a phosphoric acid fuel cell (PAFC), or a solid oxide fuel cell (SOFC). In an exemplary embodiment, the fuel cells 20 may be a polymer electrolyte membrane or proton exchange membrane (PEM) fuel cell or a solid oxide fuel cell (SOFC).

In an embodiment shown in FIG. 1C, the fuel cell stack 12 includes a plurality of proton exchange membrane (PEM) fuel cells 20. Each fuel cell 20 includes a single membrane electrode assembly (MEA) 22 and a gas diffusion layers (GDL) 24, 26 on either or both sides of the membrane electrode assembly (MEA) 22 (see FIG. 1C). The fuel cell 20 further includes a bipolar plate (BPP) 28, 30 on the external side of each gas diffusion layers (GDL) 24, 26, as shown in FIG. 1C. The above-mentioned components, in particular the bipolar plate 30, the gas diffusion layer (GDL) 26, the membrane electrode assembly (MEA) 22, and the gas diffusion layer (GDL) 24 comprise a single repeating unit 50.

The bipolar plates (BPP) 28, 30 are responsible for the transport of reactants, such as fuel 32 (e.g., hydrogen) or oxidant 34 (e.g., oxygen, air), and cooling fluid 36 (e.g., coolant and/or water) in a fuel cell 20. The bipolar plates (BPP) 28, 30 can uniformly distribute reactants 32, 34 to an active area 40 of each fuel cell 20 through oxidant flow fields 42 and/or fuel flow fields 44 formed on outer surfaces of the bipolar plates (BPP) 28, 30. The active area 40, where the electrochemical reactions occur to generate electrical power produced by the fuel cell 20, is centered, when viewing the stack 12 from a top-down perspective, within the membrane electrode assembly (MEA) 22, the gas diffusion layers (GDL) 24, 26, and the bipolar plate (BPP) 28, 30.

The bipolar plates (BPP) 28, 30 may each be formed to have reactant flow fields 42, 44 formed on opposing outer surfaces of the bipolar plate (BPP) 28, 30, and formed to have coolant flow fields 52 located within the bipolar plate (BPP) 28, 30, as shown in FIG. 1D. For example, the bipolar plate (BPP) 28, 30 can include fuel flow fields 44 for transfer of fuel 32 on one side of the plate 28, 30 for interaction with the gas diffusion layer (GDL) 26, and oxidant flow fields 42 for transfer of oxidant 34 on the second, opposite side of the plate 28, 30 for interaction with the gas diffusion layer (GDL) 24. As shown in FIG. 1D, the bipolar plates (BPP) 28, 30 can further include coolant flow fields 52 formed within the plate (BPP) 28, 30, generally centrally between the opposing outer surfaces of the plate (BPP) 28, 30. The coolant flow fields 52 facilitate the flow of cooling fluid 36 through the bipolar plate (BPP) 28, 30 in order to regulate the temperature of the plate (BPP) 28, 30 materials and the reactants. The bipolar plates (BPP) 28, 30 are compressed against adjacent gas diffusion layers (GDL) 24, 26 to isolate and/or seal one or more reactants 32, 34 within their respective pathways 44, 42 to maintain electrical conductivity, which is required for robust operation of the fuel cell 20 (see FIGS. 1C and 1D).

The fuel cell system 10 described herein, may be used in stationary and/or immovable power system, such as industrial applications and power generation plants. The fuel cell system 10 may also be implemented in conjunction with an air delivery system 18. Additionally, the fuel cell system 10 may also be implemented in conjunction with a hydrogen delivery system and/or a source of hydrogen 19 such as a pressurized tank, including a gaseous pressurized tank, cryogenic liquid storage tank, chemical storage, physical storage, stationary storage, an electrolysis system, or an electrolyzer. In one embodiment, the fuel cell system 10 is connected and/or attached in series or parallel to a hydrogen delivery system and/or a source of hydrogen 19, such as one or more hydrogen delivery systems and/or sources of hydrogen 19 in the BOP 16 (see FIG. 1A). In another embodiment, the fuel cell system 10 is not connected and/or attached in series or parallel to a hydrogen delivery system and/or a source of hydrogen 19.

In some embodiments, the fuel cell system 10 may include an on/off valve 10XV1, a pressure transducer 10PT1, a mechanical regulator 10REG, and a venturi 10VEN arranged in operable communication with each other and downstream of the hydrogen delivery system and/or source of hydrogen 19. The pressure transducer 10PT1 may be arranged between the on/off valve 10XV1 and the mechanical regulator 10REG. In some embodiments, a proportional control valve may be utilized instead of a mechanical regulator 10REG. In some embodiments, a second pressure transducer 10PT2 is arranged downstream of the venturi 10VEN, which is downstream of the mechanical regulator 10REG.

In some embodiments, the fuel cell system 10 may further include a recirculation pump 10REC downstream of the stack 12 and operably connected to the venturi 10VEN. The fuel cell system 10 may also include a further on/off valve 10XV2 downstream of the stack 12, and a pressure transfer valve 10PSV.

The present fuel cell system 10 may also be comprised in mobile applications. In an exemplary embodiment, the fuel cell system 10 is in a vehicle and/or a powertrain 100. A vehicle 100 comprising the present fuel cell system 10 may be an automobile, a pass car, a bus, a truck, a train, a locomotive, an aircraft, a light duty vehicle, a medium duty vehicle, or a heavy-duty vehicle. Type of vehicles 100 can also include, but are not limited to commercial vehicles and engines, trains, trolleys, trams, planes, buses, ships, boats, and other known vehicles, as well as other machinery and/or manufacturing devices, equipment, installations, among others.

The vehicle and/or a powertrain 100 may be used on roadways, highways, railways, airways, and/or waterways. The vehicle 100 may be used in applications including but not limited to off highway transit, bobtails, and/or mining equipment. For example, an exemplary embodiment of mining equipment vehicle 100 is a mining truck or a mine haul truck.

In addition, it may be appreciated by a person of ordinary skill in the art that the fuel cell system 10, fuel cell stack 12, and/or fuel cell 20 described in the present disclosure may be substituted for any electrochemical system, such as an electrolysis system (e.g., an electrolyzer), an electrolyzer stack, and/or an electrolyzer cell (EC), respectively. As such, in some embodiments, the features and aspects described and taught in the present disclosure regarding the fuel cell system 10, stack 12, or cell 20 also relate to an electrolyzer, an electrolyzer stack, and/or an electrolyzer cell (EC). In further embodiments, the features and aspects described or taught in the present disclosure do not relate, and are therefore distinguishable from, those of an electrolyzer, an electrolyzer stack, and/or an electrolyzer cell (EC).

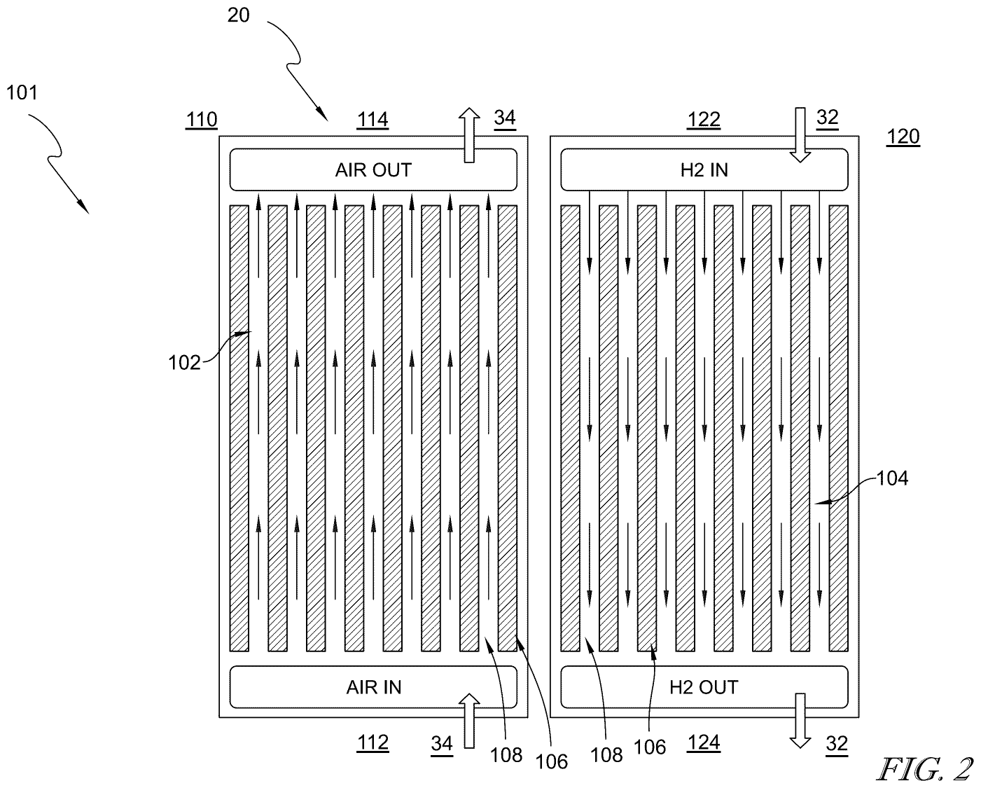

FIG. 2 shows the fuel cell 20 including a counter flow field design 101. Low pressure channels or flow fields 102, 104 at the cathode 110 and anode 120, respectively, are arranged in a counter flow direction. Air 34 in the cathode side 110 and hydrogen 32 (or fuel) in the anode side 120 flow in opposite directions. Air 34 enters the cathode 110 at the cathode inlet 112, flows through the cathode channels or flow fields 102, and exits the cathode 110 at the cathode outlet 114. Hydrogen 32 enters the anode 120 at the anode inlet 122, flows through the anode channels or flow fields 104, and exits the anode 120 at the anode outlet 124. The channels or flow fields 102, 104 include lands 106 and grooves 108.

The flow fields 102, 104 consist of one or more millimeter scale networks that direct the bulk supply of reactants (e.g., air 34 and hydrogen 32) and/or diffuse the reactants 34, 32 over the active area 40 of the fuel cell 20. The active area 40 of the fuel cell 20 is the main portion of the fuel cell 20 where both the anode and cathode flow fields 102, 104 directly overlap. The open-faced channel of the anode and cathode flow fields 102, 104 are exposed directly overtop the gas diffusion layer (GDL) 24, 26 (see FIG. 1D) and the membrane electrode assembly (MEA) 22. Hydrogen 32 present in the active area 40 of the membrane electrode assembly (MEA) 22 may produce a voltage potential and a current draw or a load may be supported by a reactant flow rate.

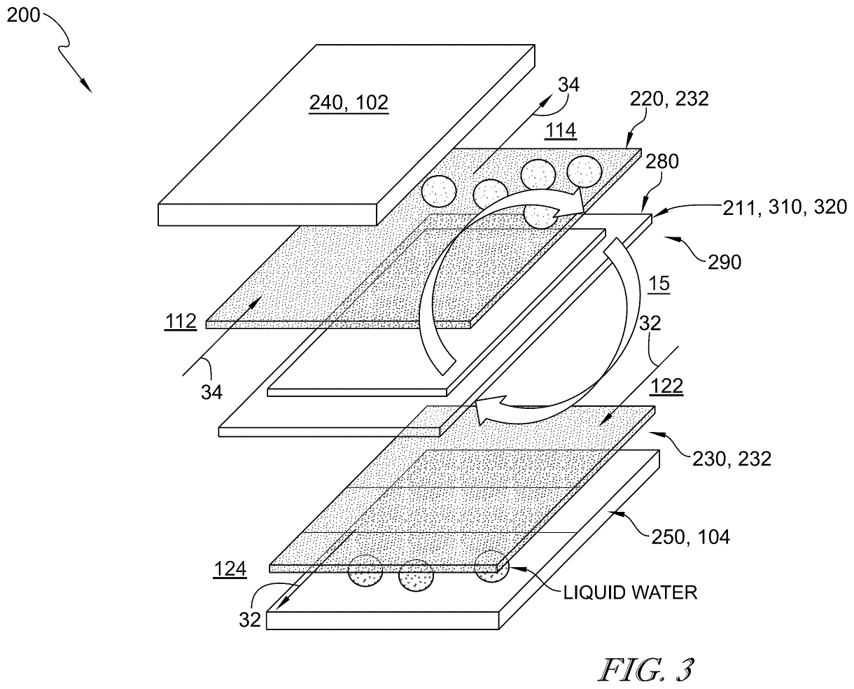

FIG. 3 shows an embodiment of a fuel cell 200 including a membrane electrode assembly (MEA) 210. The fuel cell 200 also comprises an anode gas diffusion layer (GDL) 230 and a cathode gas diffusion layer (GDL) 220 on either side of the membrane electrode assembly (MEA) 210. Finally, the fuel cell 200 also comprises bipolar plates (BPP) 240, 250 including the cathode flow field 102 and the anode flow field 104, respectively. Air 34 enters at the cathode inlet 112 and exits at the cathode outlet 114. Hydrogen 32 enters at the anode inlet 122 and exits at the anode outlet 124.

The gas diffusion layers (GDL) 230, 220 in the fuel cell 200 each have three primary roles. The GDLs 230, 220 physically enable uniform and laminar diffusion from the flow fields 102, 104 to the membrane electrode assembly (MEA) 210. The GDLs 230, 220 create the uniform flow and/or diffusion by leveraging a porous and finely meshed network of fibers (e.g., graphite fibers) 232. The network of fibers 232 functions as a flow straightener in order to reduce the turbulence of the hydrogen 32 and the air 34 and provides a steady stream of reactants 34, 32 to a reaction site 280.

The gas diffusion layers (GDL) 230, 220 are typically hydrophobic and repel any liquid water 15 away from the reaction site 280. Since water 15 is a byproduct of fuel cell reactions, there may be instances where condensation is thermodynamically favored to form water 15 at the surface of the fuel cell 200. Removal of water 15 from the reaction site 280 is critical because liquid water 15 may effectively block the air 34 and the hydrogen 32, i.e., the reactants 34, 32, from reaching the reaction site 280. Additionally, if excessive liquid water 15 is left in contact with the membrane electrode assembly (MEA) 210, the water 15 can cause accelerated aging of the fuel cell 200 by reacting with a cathode catalyst layer 310 and an anode catalyst layer 320 of the membrane electrode assembly (MEA) 210.

The bipolar plates (BPP) 240, 250 are responsible for the transport of reactants 34, 32 and cooling fluid 36 in the fuel cell 200. The bipolar plates (BPP) 240, 250 are responsible for uniformly distributing the reactants 34, 32 to an active area 290 of each fuel cell 200 through cathode channels or flow fields 102 and/or the anode channels or flow fields 104. The active area 290, where the electrochemical reactions occur to generate power produced by the fuel cell 200, may be centered within the GDL 220, 230 and the bipolar plate (BPP) 240, 250. In other embodiments, the bipolar plates (BPP) 240, 250 may be responsible for isolating or sealing the reactants 34, 32 within their respective pathways, while being electrically conductive and robust.

As shown in FIGS. 3 and 4, the water 15 produced in the active area 290 of the fuel cell 200 is circulated through the anode flow fields 104, the cathode flow fields 102, and the GDLs 220, 230. FIG. 4 illustrates a cross section 300 of the fuel cell 200 including a single anode flow field 104. The fuel cell 200 includes the cathode catalyst layer 310 and the anode catalyst layer 320 coated membrane 211 sandwiched between two hydrophobic GDLs 220, 230 with a hydrophobic cathode microporous layer (MPL) 330 and a hydrophobic anode microporous layer (MPL) 340.

The hydrophobic cathode MPL 330 and the hydrophobic anode MPL 340 are subsequently sandwiched between the two flow fields 102, 104. Hydrogen 32 at the anode side 120 and oxygen from air 34 at the cathode side 110 diffuse through the respective hydrophobic GDLs 230, 220 and hydrophobic MPLs 340, 330. In high humidity conditions and under high current densities, liquid water 15 present in the catalyst layers 320, 310 flows away from the catalyst layers 320, 310 via capillary flow. Typical hydrophobic GDLs 220, 230 and hydrophobic MPLs 330, 340 offer hydraulic resistance to the liquid water 15 flowing away from the catalyst layers 320, 310. The resistance leads to the presence of liquid water 15 in the catalyst layers 310, 320, in the MPLs 330, 340, and/or in the GDLs 230, 220.

Accumulation of liquid water 15 can trigger flooding and ultimately reduce both the performance and the durability of the fuel cell 200. The relative humidity of the fuel cell 200 increases with an increase in liquid water 15 accumulation. The increase in liquid water 15 accumulation also makes the fuel cell 200 increasingly susceptible to flooding and or displacement of the air 34 molecules. Liquid water 15 accumulation may take place towards the exit of the anode flow fields 104, where flooding and subsequent displacement of fuel 32 is likely to persist.

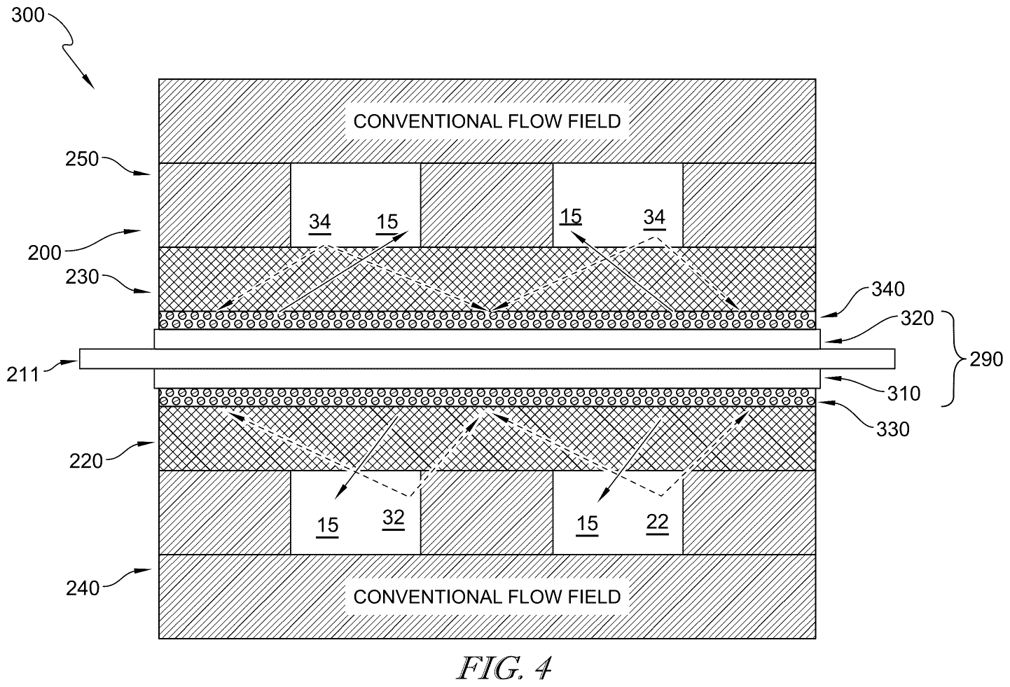

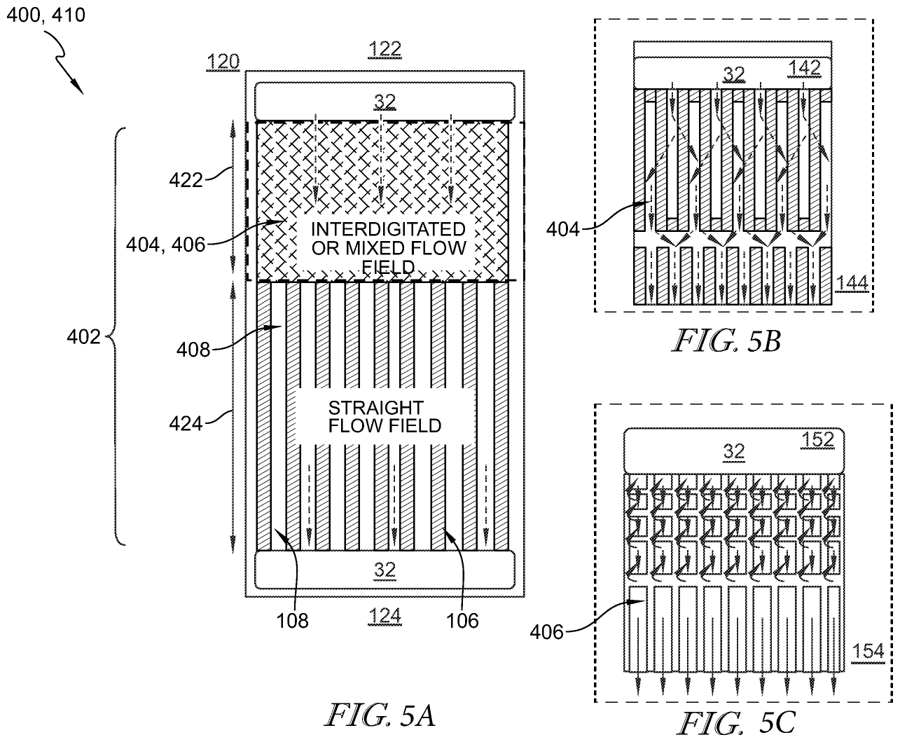

FIG. 5A shows a top view 410 of a fuel cell 400 employing a composite flow field design at the anode 120. Hydrogen 32 enters the anode 120 at the anode inlet 122, flows through a composite anode channel or flow field 402, and exits the anode 120 at the anode outlet 124. The composite anode flow fields 402 may include an interdigitated channel or flow field 404, a mixed channel or flow field 406, and/or a parallel channel or flow field 408. In some embodiments, the fuel cell 400 may include one or more of the interdigitated channel or flow field 404, the mixed channel or flow field 406, and the parallel channel or flow field 408.

If the composite anode flow field 402 includes the interdigitated flow field 404, hydrogen 32 enters the interdigitated flow field 404 at an anode inlet 142 and exits the interdigitated flow field 404 at an anode outlet 144 before entering the parallel flow fields 408, as shown in FIG. 5B. If the composite anode flow field 402 includes the mixed flow field 406, hydrogen 32 enters the mixed flow field 406 at an anode inlet 152 and exits the mixed flow field 406 at an anode outlet 154 before entering the parallel flow fields 408, as shown in FIG. 5C.

In one embodiment, the interdigitated flow field 404 and/or the mixed flow field 406 may include a first length 422 of the composite anode flow field 402, and the parallel flow field 408 may include a second length 424 of the composite anode flow field 402. The ratio of the first length 422 to the second length 424 may be 1:10, 1:8, 1:6, 1:4, 1:2, 1:1, or any ratio or range of ratio comprised therein. The ratio of the first length 422 to the second length 424 may depend on fuel cell stack design and/or orientation. In some embodiments, the composite anode flow field 402 may include the interdigitated flow field 404, the mixed field 406, and the parallel flow field 408 with the same or varying lengths.

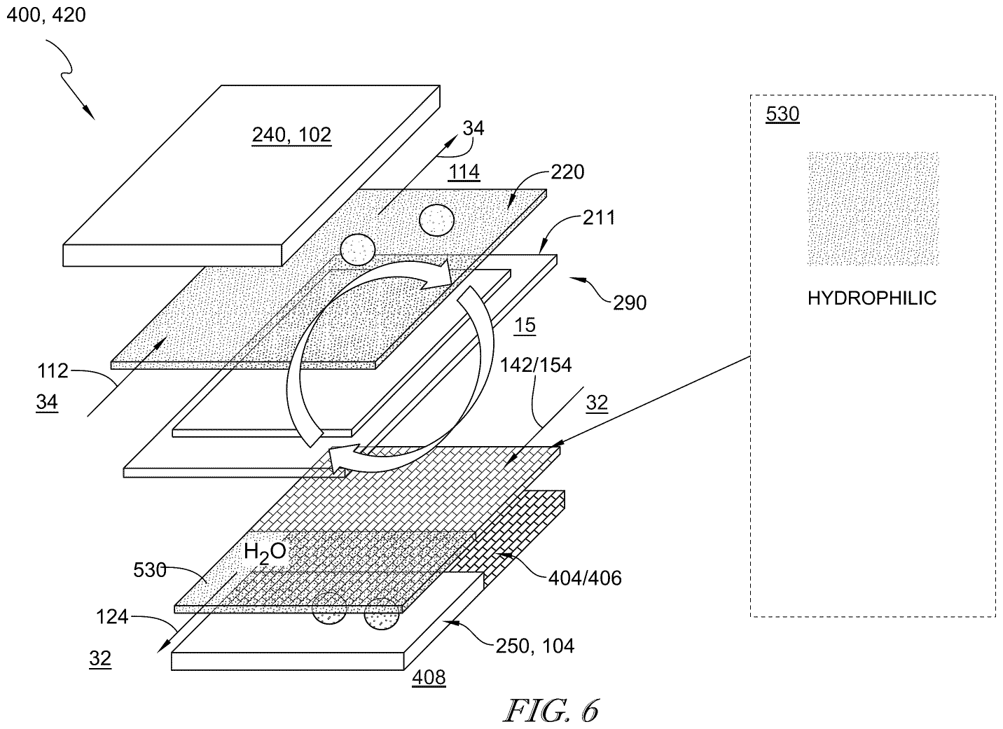

FIG. 6 shows an exploded view 420 of the fuel cell 400 with the composite anode flow field 402 that comprises the interdigitated flow field 404 or the mixed flow field 406 along with the parallel flow field 408. Hydrogen 32 enters the anode inlet 142/152 and exits the anode outlet 124. The ratio of the lengths 422 of the interdigitated flow field 404 or the mixed flow field 406 to the length 424 of the parallel flow field 408 may determine the relative humidity in the fuel cell 400.

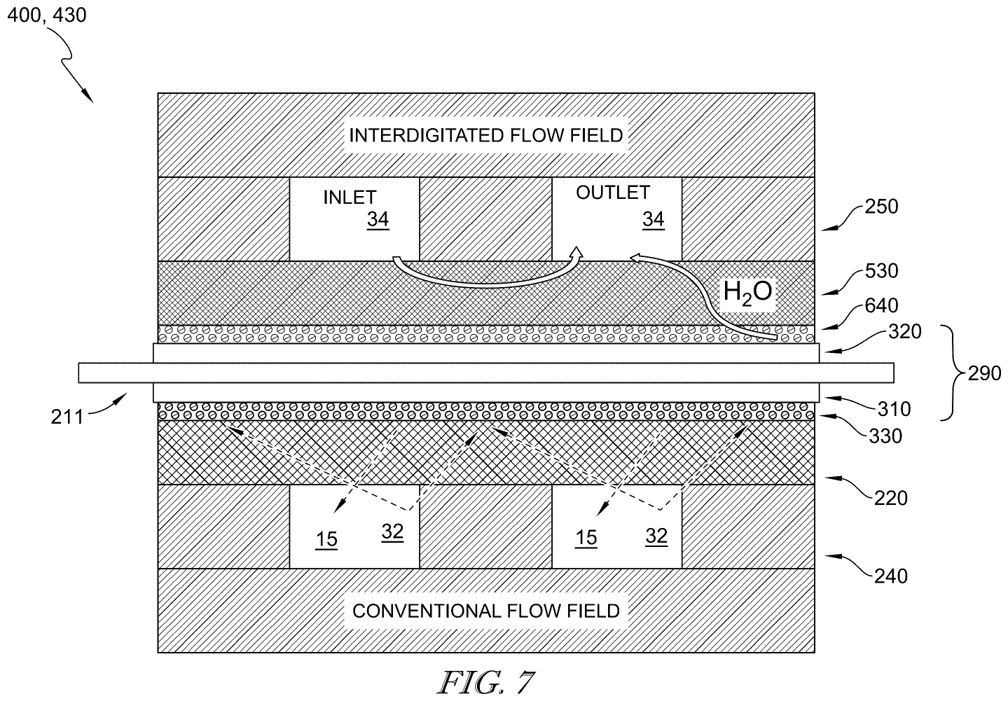

FIG. 7 illustrates a cross-section view 430 of the fuel cell 400 including the composite anode flow field 402. In the portion of the composite anode flow field 402 corresponding to the interdigitated flow field 404 or the mixed flow field 406, an anode GDL 530 and an anode MPL 640 may be hydrophilic or hydrophobic. In some embodiments, the portion of the anode GDL 530 corresponding to the interdigitated flow field 404 or the mixed flow field 406 may be hydrophilic and may not be hydrophobic.

As shown in FIGS. 6 and 7, the fuel cell 400 includes the anode catalyst layer 320 and the cathode catalyst layer 310 coated membrane 211 sandwiched between the hydrophobic GDL 220 and the hydrophobic cathode MPL 330 on one side and a partially hydrophilic GDL 530 with a partially hydrophilic anode MPL 640 on the other side. The water 15 produced in the active area 290 of the fuel cell 400 is circulated through the composite anode flow field 402, the cathode flow fields 102, the MPLs 330, 640, and the GDLs 220, 530.

Liquid water 15 is produced in the cathode catalyst layer 310 during the electrochemical reactions. As shown in FIGS. 3, 4, 6, and 7, there is an increase in the recirculation of liquid water 15 in the fuel cell 400 compared to the fuel cell 200. The increase in recirculation is attributed to both the composite configuration of the anode flow field 402 and to the presence of the hydrophilic GDL 530 and the hydrophilic MPL 640.

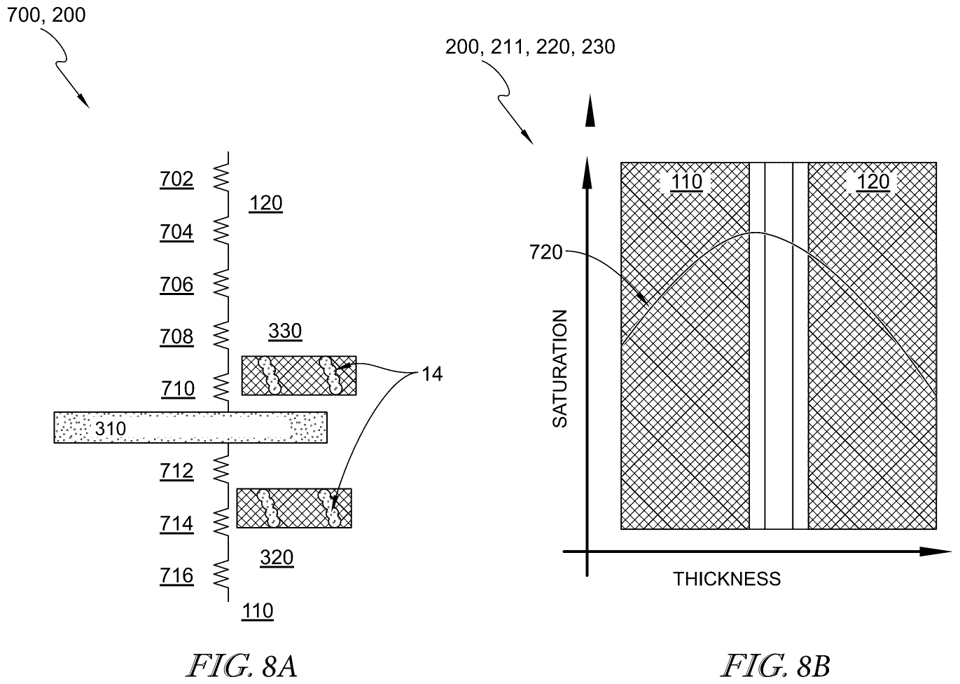

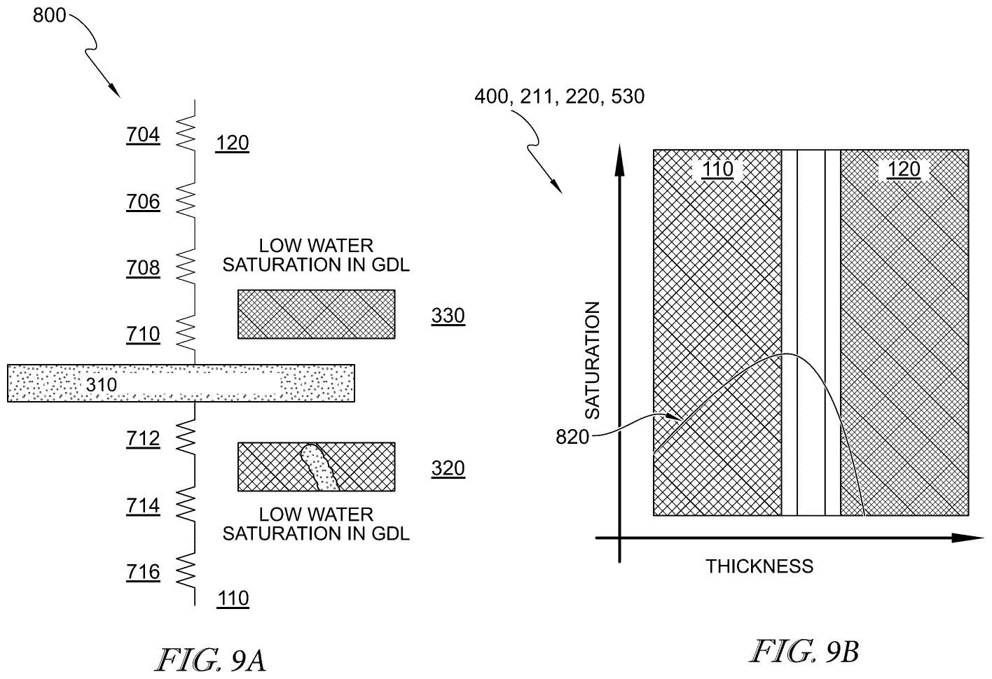

FIG. 8A is a representation of hydraulic resistance 700 corresponding to the fuel cell 200 shown in FIGS. 3 and 4. FIG. 9A is a representation of hydraulic resistance 800 corresponding to the fuel cell 400 shown in FIGS. 6 and 7. A hydraulic resistance 702 of the anode GDL 230, 530 is positioned at the anode flow field 104/402 interface. A hydraulic resistance 704 of the anode GDL 230, 530, a hydraulic resistance 706 of the anode MPL 340, 640, a hydraulic resistance 708 of the anode catalyst layer 320, a hydraulic resistance 710 of the membrane 211, a hydraulic resistance 712 of the cathode MPL 330, and a hydraulic resistance 714 of the cathode GDL 220 is shown in FIG. 8A. A hydraulic resistance 716 of the cathode GDL 220 is positioned at the cathode flow field 102 interface.

As shown in FIG. 8A, the hydrophobic hydraulic resistance 702, 704, 706, 712, 714, 716 is much larger than hydrophilic hydraulic resistance 708, 710 in the typical fuel cell 200. Thus, effectively for any symmetric fuel cell assembly as shown in FIGS. 3 and 4, hydraulic resistances at both the anode 120 and the cathode 110 side are similar. Thus, there may be an equal amount of liquid water 15 at the anode 120 and the cathode 110. Since liquid water 15 is generated at the cathode catalyst layer 310, most of the liquid water 15 can leave the cathode 110 and cause flooding at the anode 120 at high current density operating conditions. As shown in FIG. 8B, a water saturation profile 720 along the thickness of membrane 211 and across the GDLs 220, 230 of the fuel cell 200 shows that the local water saturation is about 10% to about 40% higher at the cathode 110 compared to the anode 120.

In an asymmetric assembly, as shown in FIGS. 6 and 7, the combined effect of convection due to the pressure driven hydrogen 32 flow and wicking of water 15 away from the catalyst layers 310, 320 via the hydrophilic GDL 530 and the hydrophilic MPL 640 significantly reduces the hydraulic resistance at the anode 120 side. As shown in FIG. 9A, the fuel cell 400 allows much more facile transport of water 15 away from the cathode catalyst layer 310 thereby reducing the water 15 saturation at the cathode 110 side and improves oxygen diffusion to the cathode catalyst layer 310.

A water saturation profile 820 along the thickness of membrane 211 and across the GDL 220, 530 of the fuel cell 400 is shown in FIG. 9B. The local water saturation is higher at the cathode 110, and the local water saturation at the anode 120 is lower compared to the water saturation profile 720 corresponding to the fuel cell 200. The amount of water 15 in the anode 120 is about 10% to about 40% lower than the water 15 in the cathode 110.

Recycling or recirculation the liquid water 15 by allowing the water 15 to flow through the hydrophilic anode GDL 530 and exit into the anode flow fields 104 results in humidification of the hydrogen 32 at the anode outlet 124, removal of air 34 from the cathode outlet 114, and humidification of air 34 in the cathode inlet 112. Some fuel cell systems using the fuel cell 400 with a composite anode flow field 104 and the hydrophilic GDL 530 may not need a humidifier or may need a smaller humidifier compared to when using the fuel cell 200. Thus, recycling or recirculation of the liquid water 15 may lessen the parasitic load on the fuel cell system.

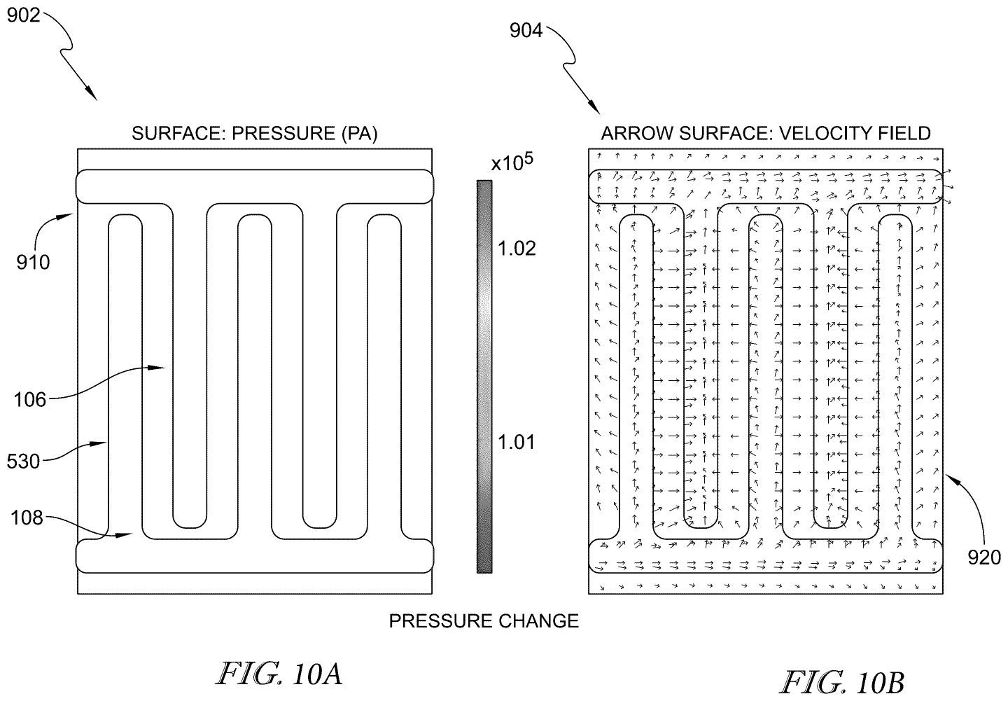

A method of flowing hydrogen 32 through the anode flow fields 104, 402 may include inducing a pressure drop across the lands 106 and the grooves 108 in the anode flow field 104, 402. The land 106 is a solid part of flow field 104, 402 in contact with GDL 530, and the groove 108 is a channel through which hydrogen 32 flows and diffuses into the GDL 530. FIG. 10 shows a pressure simulation 902 (see FIG. 10A) and a velocity simulation 904 (see FIG. 10B) during hydrogen 32 flow in the interdigitated anode flow field 404. The hydrogen 32 flow rate in the simulation has a stoich of 2 at about 3 Amps/cm², the permeability of hydrogen 32 across the GDL 530 is about 10⁻¹⁰ m², and the width of the land 106 and groove 108 is about 0.75 mm each. As shown in a graph 910, the presence of the interdigitated anode flow field 404 does not introduce any additional pressure drop in the anode flow field 402. Additionally, the flow of hydrogen 32 under the lands 106 and grooves 108 is uniform as shown in a graph 920.

The material and structure of the bipolar plates (BPP) 240, 250 are important to the conductivity of the fuel cell 400. In some embodiments, the material of the bipolar plates (BPP) 240, 250 is graphite. In other embodiments, the material of the bipolar plates (BPP) 240, 250 is not graphite. Similarly, the material of the bipolar plates (BPP) 240, 250 may or may not be a similar or different powder-based product that may be prepared by an impregnation and/or solidifying process, such as graphite. Exemplary materials of the present bipolar plates (BPP) 240, 250 include a metal and/or a combination of one or more metals.

The metal of the bipolar plates (BPP) 240, 250 may be any type of electrically conductive metal. Electrically conductive metals appropriate or the present metal BPP include, but are not limited to, Austenitic stainless steel (304L, 316L, 904L, 310S), Ferritic stainless steel (430, 441, 444, Crofer), Nickel based alloys (200/201, 286, 600, 625), Titanium (Grade 1, Grade 2), or Aluminum (1000 series, 3000 series). Exemplary metals comprised by the bipolar plates (BPP) 240, 250 may be steel, iron, nickel, aluminum, and titanium.

The bipolar plates (BPP) 240, 250 may include one or more, multiple, or a plurality of sheets. Sheets of the metal bipolar plates (BPP) 240, 250 may be sealed, welded, stamped, structured, bonded, and/or configured to provide the flow fields 102, 402 for the fuel cell 400 fluids. One or more sheets of the bipolar plates (BPP) 240, 250 are configured to be in contact, to overlap, to be attached, or connected to one another in order to provide the flow fields for the fuel cell 400 fluids.

One or more sheets of the bipolar plate (BPP) 240, 250 may be coated for corrosion resistance. In some embodiments, the corrosion resistant coating may be a graphite based coating. Since graphite has the inability to oxidize, it may be advantageous to coat metal with graphite to prevent corrosion and/or oxidation of the BPPs 240, 250 in order to enhance performance of the fuel cell 400.

The features illustrated or described in connection with one exemplary embodiment may be combined with any other feature or element of any other embodiment described herein. Such modifications and variations are intended to be included within the scope of the present disclosure. Further, a person skilled in the art will recognize that terms commonly known to those skilled in the art may be used interchangeably herein.

The above embodiments are described in sufficient detail to enable those skilled in the art to practice what is claimed and it is to be understood that logical, mechanical, and electrical changes may be made without departing from the spirit and scope of the claims. The detailed description is, therefore, not to be taken in a limiting sense.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Specified numerical ranges of units, measurements, and/or values comprise, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first,” “second,” “third” and the like, as used herein do not denote any order or importance, but rather are used to distinguish one element from another. The term “or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising,” “including,” or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps.

The phrase “consisting of” or “consists of” refers to a compound, composition, formulation, or method that excludes the presence of any additional elements, components, or method steps. The term “consisting of” also refers to a compound, composition, formulation, or method of the present disclosure that excludes the presence of any additional elements, components, or method steps.

The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “about,” and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A fuel cell system comprising a fuel cell including:
an anode and a cathode,
a membrane electrode assembly on a first side of an anode gas diffusion layer,
a bipolar plate on a second side of the anode gas diffusion layer comprising an anode flow field, and
a microporous layer in between the membrane electrode assembly and the anode gas diffusion layer,
wherein the anode flow field comprises at least a first anode flow field configuration and a second anode flow field configuration, and wherein hydrogen flows through the first anode flow field configuration and the second anode flow field configuration of the anode flow fields.

2. The system of claim 1, wherein the first anode flow field configuration is an interdigitated flow configuration and the second anode flow field configuration is a parallel flow configuration.

3. The system of claim 1, wherein the first anode flow field configuration is a mixed flow configuration and the second anode flow field configuration is a parallel flow configuration.

4. The system of claim 1, wherein a ratio of a length of the first anode flow field configuration to a length of the second anode flow field configuration is about 1:1.

5. The system of claim 1, wherein the anode gas diffusion layer comprises a first anode gas diffusion layer corresponding to the first anode flow field configuration and a second anode gas diffusion layer corresponding to the second anode flow field configuration, and wherein the first anode gas diffusion layer is hydrophilic and the second anode gas diffusion layer is hydrophobic.

6. The system of claim 5, wherein the hydrophilic first anode gas diffusion layer causes an anode side hydraulic resistance to be lower than a cathode side hydraulic resistance.

7. The system of claim 1, wherein a pressure drop in the first anode flow field configuration is about the same as a pressure drop in the second anode flow field configuration.

8. The system of claim 1, wherein a velocity of hydrogen flowing through the first anode flow field configuration is about the same as a velocity of hydrogen flowing through the second anode flow field configuration.

9. The system of claim 1, wherein the first anode flow field configuration includes a first grove of a width about 0.2 mm to 1 mm and the second anode flow field configuration includes a second grove of a width about 0.2 mm to 1 mm.

10. The system of claim 1, wherein a first local water saturation at the anode is lower than a second local water saturation at the cathode.

11. A method of operating a fuel cell system including a fuel cell stack comprising:
operating a plurality of fuel cells comprising a membrane electrode assembly on a first side of an anode gas diffusion layer and a bipolar plate on a second side of the anode gas diffusion layer, wherein the anode gas diffusion layer comprises a first anode flow field configuration and a second anode flow field configuration,
flowing hydrogen through the first anode flow field configuration and the second anode flow field configuration,
increasing efficiency of the fuel cell system by decreasing water accumulation in the fuel cell stack.

12. The method of claim 11, wherein the first anode flow field configuration is an interdigitated flow configuration and the second anode flow field configuration is a parallel flow configuration.

13. The method of claim 11, wherein the first anode flow field configuration is a mixed flow configuration and the second anode flow field configuration is a parallel flow configuration.

14. The method of claim 11, wherein the anode gas diffusion layer comprises a first anode gas diffusion layer corresponding to the first anode flow field configuration and a second anode gas diffusion layer corresponding to the second anode flow field configuration, and wherein the first anode gas diffusion layer is hydrophilic and the second anode gas diffusion layer is hydrophobic.

15. The method of claim 14, wherein the method further comprises recycling water produced in the fuel cell stack by allowing the water to flow through the hydrophilic first anode gas diffusion layer.

16. The method of claim 15, wherein the method further comprises decreasing a parasitic load on the fuel cell system.

17. The method of claim 11, wherein the method further comprises humidifying air at a cathode inlet of each of the plurality of fuel cells by recycling water produced in the fuel cell stack.

18. The method of claim 11, wherein the method further comprises humidifying hydrogen at an anode outlet of each of the plurality of fuel cells by recycling water produced in the fuel cell stack.

19. The method of claim 11, wherein a pressure drop in the first anode flow field configuration is about the same as a pressure drop in the second anode flow field configuration.

20. The method of claim 11, wherein a fluid velocity in the first anode flow field configuration is about the same as a fluid velocity in the second anode flow field configuration.
